(19) United States
(12) Patent Application Publication
(10) Pub. No.: US 2009/0031251 A1
(43) Pub. Date: Jan. 29, 2009

(54) Wireless Management Interface

(75) Inventors: Shawn Kessler, Potomac, MD (US); Peter Feinberg, McLean, VA (US); Paul Pavlicheck, Frederick, MD (US); Allan Hakky, Bedford, MA (US)

Correspondence Address: BRIAN J. DETWILER, 525 N. POLLARD STREET, APT. 309, ARLINGTON, VA, 22203, US

(73) Assignee: GOFERTECH, LLC, Potomac, MD (US)

(21) Appl. No.: 12/178,528

(22) Filed: Jul. 23, 2008

Related U.S. Application Data
(60) Provisional application No. 60/951,531, filed on Jul. 24, 2007.
(60) Provisional application No. 60/978,183, filed on Oct. 8, 2007.

(51) Int. Cl. G06F 3/048

(52) U.S. Cl. 715/810

(57) ABSTRACT

It is an object of the present invention to overcome the limitations of the prior art through the use of a wireless management interface (WMI). The WMI enables a user to securely manage the wireless transfer and synchronization of data between two or more wireless-equipped devices. The WMI is preferably implemented in a combination of hardware and software and operates by enabling a user, via a graphical display and user input capabilities, to establish a communication profile for any two or more devices. The communication profile includes one or more content parameters and one or more timing parameters. In response to receiving configuration instructions from the WMI, the devices then operate to transfer or synchronize designated content at a designated time according to the communication profile. Synchronization is further facilitated by a database that is accessible to the WMI and maintains the communication profiles and other device-specific configuration information.

This application claims the benefit of U.S. Provisional Patent Applications 60/951,531, filed 24 Jul. 2007, and 60/978,183, filed 8 Oct. 2007.

### BACKGROUND AND SUMMARY OF THE INVENTION

It is not uncommon for consumers to utilize multiple computer systems and electronic devices throughout their daily routines. For example, a consumer may have a computer at home and another at work, a cell phone, a wireless headset, an MP3 player, etc. These devices are primarily used for communication and/or data storage, but it is often not easy to share and synchronize data between them. Wireless protocols, such as Bluetooth, allow for data transmission between compatible devices, but many modern devices are not interoperable with each other because the devices may operate on different platforms, they may lack a necessary user interface, or they may simply be designed to communicate only with specific manufacturer-designated devices. For example, users cannot wirelessly transfer photos from a digital camera to a cell phone, slide presentations from a PDA to a USB flash drive, or audio files from an MP3 player to a headset. Such limitations require users to carry and operate multiple devices when one would be sufficient, or utilize more inefficient means (e.g., hardware data cables) to transfer data between devices.

Consider, for example, the office worker that frequently uses one PC at work and another at home to edit the same set of documents. Conventional technologies require the user to store the documents in a network location accessible from both work and home, to store all the documents on a portable hard drive or USB flash drive, or consistently email the documents between work and home email accounts. Storing the documents in an accessible network location often requires a costly infrastructure or may not be possible due to security and/or firewall constraints. Keeping the documents on a portable storage device can be risky and inconvenient, especially if the device is lost or it malfunctions. Finally, emailing the documents back and forth can be cumbersome and confusing, particularly when there may be multiple version of a particular document. It would therefore be advantageous if there was a solution for synchronizing the documents among the home and work PCs that was more secure and convenient from the user's perspective.

As wireless technology continues to decrease in size and increase and capabilities, it is becoming more prevalent in everyday devices. Implementing the technology, however, is only half the battle. There still lacks a universal solution for enabling a user to transfer content between two wireless-equipped devices that are not interoperable out of the box. Consider a second example, where a user takes photos with a digital camera while traveling and wants to transmit those photos to friends or coworkers via email or messaging capabilities on a cell phone. Even if both the digital camera and the cell phone are equipped with compatible wireless communication capabilities, it is presently very unlikely that the devices could exchange information. Unless some proprietary application was installed on each device, the user would be required to wait until a computer was available to download the photos from the camera and transmit them to his or her friends via the Internet. Accordingly, it would also be advantageous if a user could pre-configure two devices, such as a digital camera and a cell phone, to wirelessly transfer designated content from one device to the other either automatically or in response to a specific user input.

In addition to improving the interoperability among existing devices, there are numerous improvements that can be made to the devices themselves to further reduce the complexity and inconvenience of transferring and synchronizing content. For example, one device that continues to see an increase in popularity is the wireless headset that enables users to make and receive phone calls in a hands-free manner. Many users utilize these headsets at home, in the car, at work, in a hotel, etc. Since the headset goes wherever the user goes, it would be highly convenient if wireless headsets could also function as portable storage devices. Presently, however, there are no headsets on the market that can store and wirelessly transfer content. This may largely be due to the fact that there are no suitable means for effectively utilizing the storage capabilities.

Similarly, USB flash drives are also highly prevalent. Because of their small size and increasing capacity, they are frequently used to physically transport data from one geographic location to another. USB flash drives, however, are limited to communicating only with other devices comprising a USB port. This limitation significantly reduces the number of devices with which USB flash drives are interoperable. For example, most cell phones, PDAs, headsets, and MP3 players lack USB ports. Accordingly, it would also be convenient if one could transfer content between a wireless flash drive and other wireless equipped devices such as those mentioned above. Again, there are presently no wireless flash drives with such capabilities on the market. Why has such technology not become a reality? The primary constraint is the lack of means for enabling a user to easily transfer or synchronize content between these devices. It would thus be advantageous to provide a standardized interface with which a user can configure an unlimited number of existing and future devices to transfer and synchronize content at designated times or in response to certain user inputs.

It is an object of the present invention to overcome the limitations of the prior art through the use of a wireless management interface (WMI). The WMI enables a user to securely manage the wireless transfer and synchronization of data between two or more wireless-equipped devices. The WMI is preferably implemented in a combination of hardware and software and operates by enabling a user, via a graphical display and user input capabilities, to establish a communication profile for any two or more devices. The communication profile includes one or more content parameters and one or more timing parameters. In response to receiving configuration instructions from the WMI, the devices then operate to transfer or synchronize designated content at a designated time according to the communication profile. Synchronization is further facilitated by a database that is accessible to the WMI and maintains the communication profiles and other device-specific configuration information.

In one embodiment of the present invention, content is automatically transferred from a first device to a second device when the devices are within wireless communication range of each other. In an alternative embodiment, content is transferred from a first device to a second device in response to user input at one of the devices.

In a further embodiment of the invention, a profile is established between a first device and a class of devices, wherein the first device can be configured to receive content from any device within the class of devices. Example classes could include: all devices, business devices, entertainment devices, information devices, and advertising devices.

In a further embodiment of the invention, the WMI is updatable (e.g., via the Internet) so as to support new devices and accommodate new types of content.

### BRIEF DESCRIPTION OF THE DRAWINGS

The invention is explained in further detail, and by way of example, with reference to the accompanying drawings wherein:

FIG. 1 illustrates an example diagram of a wireless communication system in accordance with this invention.

FIG. 2 illustrates an example flow diagram for interactively configuring profiles in accordance with this invention.

FIG. 3 illustrates an example flow diagram for automatically and manually initiating transfer or synchronization operations in accordance with this invention.

FIG. 4A illustrates an example device dataset in accordance with this invention.

FIG. 4B illustrates example profile dataset in accordance with this invention.

### DETAILED DESCRIPTION

In the following description, for purposes of explanation rather than limitation, specific details are set forth such as the particular architecture, interfaces, techniques, etc., to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

There are an infinite number of uses for synchronizing data files across multiple devices. Prior art techniques, however, have been very limited in their ability to enable consumers to easily transfer or synchronize content wirelessly between common devices. Consumers presently face arduous configuration processes and limited functionality with even the most advanced devices on the market, and they will typically either abandon their effort to synchronize files, or rely on physical connections that can be cumbersome and altogether inconvenient. The invention described herein addresses these and other problems in the prior art.

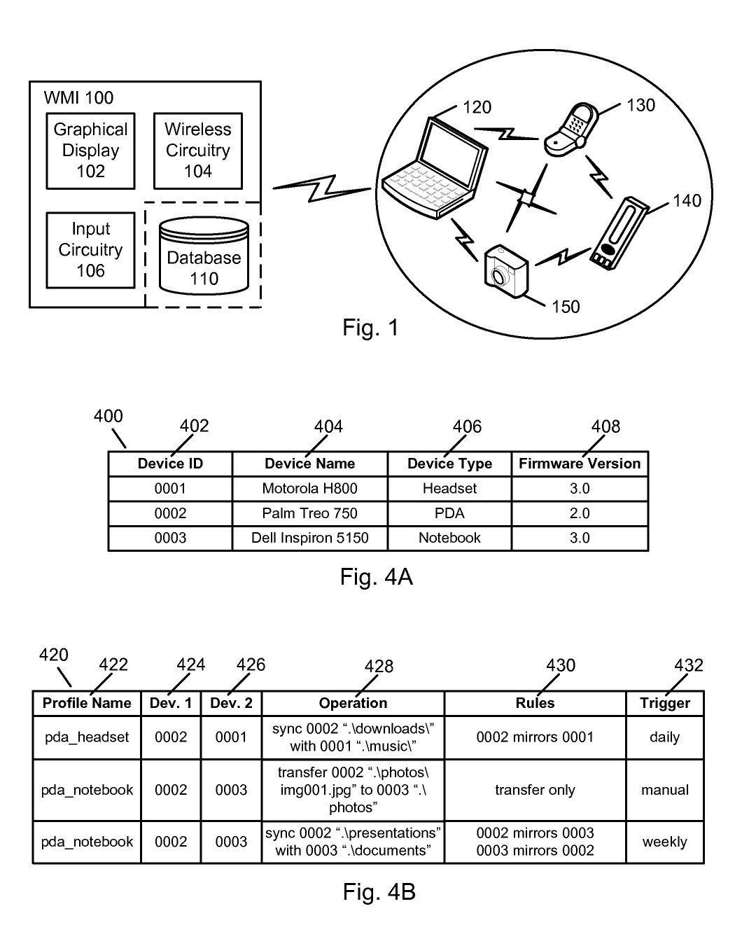

FIG. 1 illustrates an exemplary embodiment of the present invention. A user might have a notebook computer 120, a cell phone 130, a wireless flash drive 140, and/or a digital camera 150. Each of the devices in this example is capable of wireless communication and comprises a data storage component. In the preferred embodiment, wireless communication is preferably provided in accordance with the Bluetooth protocol because it supports a compact, low cost, and low power consumption solution for portable devices. It should be understood by one of ordinary skill in the art that other wireless technologies may be equally suitable for this invention. For example, WiFi, Radio Frequency (RF), infrared or any other wireless communication means could be implemented and not depart from the intended scope. The data storage component for smaller devices, such as cell phone 130 and wireless flash drive 140, is preferably flash memory because it is compact, non-volatile, and offers fast read access times. Larger devices, such as notebook computer 120, might utilize a hard disk or some other high-capacity solution. Again, it should be understood that other storage technologies might be equally suitable for this invention, and the discussion of one in particular is not meant to limit the scope.

Out of the box, it is unlikely that a user can wirelessly transfer content between any two or more of devices 120-150 with ease. In many cases, this is because one device in any pair of devices must be capable of supporting a specific graphical user interface (GUI) that enables the user to configure the devices and manually execute data transfer operations. In the present invention, devices such as wireless flash drive 140 and digital camera 150 can exchange content even if neither device supports such a GUI. This is accomplished via a wireless management interface (WMI) 100, which supports a graphical display 102, wireless communication capabilities 104, and user input capabilities 106. The WMI 100 is preferably implemented in a combination of hardware and software and provides a graphical interface with which the user can configure an array of transfer or synchronization operations across a plurality of devices. For example, the user can use the WMI 100 to configure the wireless flash drive 140 and digital camera 150 to transfer designated content from one device to the other. Transfers can be configured to occur automatically at a certain time or when the devices are within wireless communication range of one another. Alternatively, the exchange can be configured to occur manually in response to user input at one of the devices. More detail regarding the configuration and synchronization of devices is provided in further detail below.

WMI 100 is preferably connected to a database 110, which stores device-specific configuration parameters, profile information, and other information that may be necessary to enable the WMI 100 to communicate with and configure an unlimited number of types, brands, and versions of devices. The database 110 is preferably maintained in a storage location at the WMI 100 according to well-known storage means (e.g., a hard disk), but could also be maintained remotely. For example, the database 110 could be located at a single server accessible via a network, such as the Internet, or it might be distributed across multiple servers. In all cases, the database 110 is preferably connected to the Internet so that it can be easily updated with device-specific information as new devices become available and existing devices are improved.

It is assumed that each of devices 120-150 supports the basic capabilities for accomplishing the intended tasks of this invention. In the preferred embodiment, for example, each of devices 120-150 utilizes the latest specification of the Bluetooth protocol. The Bluetooth protocol consists of various profiles, wherein each profile defines certain procedures with which devices can communicate with each other. One such profile is the File Transfer Profile (FTP), which provides support for getting folder listings, exchanging files, deleting files, etc. Similar specifications for other wireless technologies can be utilized as dictated by the particular technology in use.

It is an object of the present invention to utilize standardized specifications, such as the File Transfer Profile, as much as possible in order to minimize the cost and complexity of implementing the invention in the real world. In certain cases, the standardized specification for a particular wireless technology may not provide all of the necessary functions required by the invention, and must be supplemented by non-standardized specifications. If a particular device does not support a required specification, standardized or otherwise, its firmware can often be updated according to well-known techniques. Firmware updates are typically supplied by the device's manufacturer and distributed by ordinary means such as the Internet.

For purposes of illustration, WMI 100 has been described thus far as being independent from devices 120-150. It should be understood, however, that WMI 100 could be one of the devices 120-150 so long as it has the necessary capabilities, i.e., it can support a graphical display, it has wireless capabilities and user input capabilities, and it can access the database 110. Notebook computer 120, for example, could function as the WMI and be used to configure an exchange of content between itself and the wireless flash drive 140. Additionally, while the WMI 100 preferably communicates wirelessly with devices 120-150, it may be necessary in limited circumstances to utilize a wired connection to initially configure certain devices properly. In such cases, the WMI 100 could utilize serial, parallel, universal serial bus (USB), Firewire or other conventional device-to-device hardware communication means.

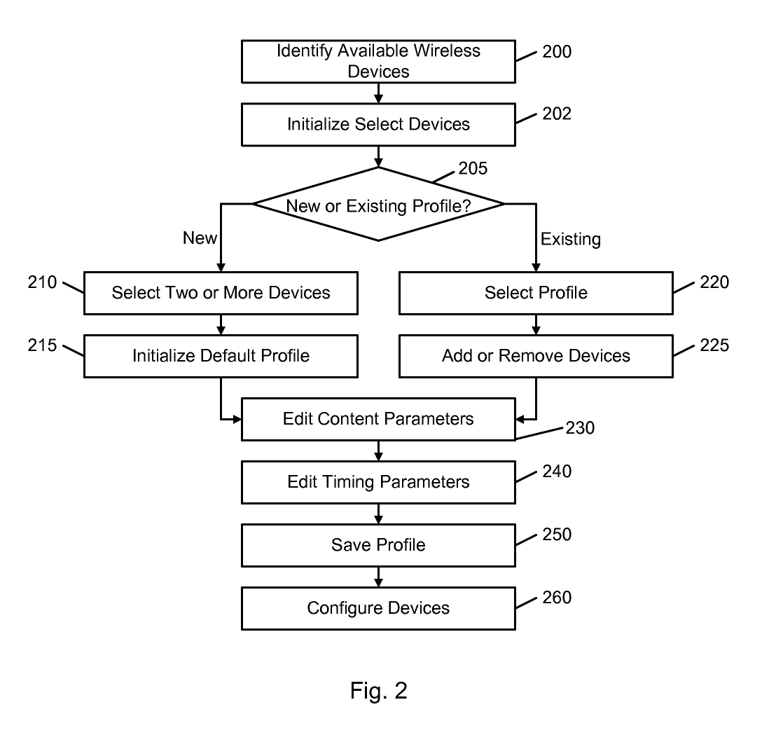

FIG. 2 illustrates an exemplary workflow with which a user can configure two or more devices to transfer designated content. At step 200, the WMI 100 identifies available wireless devices 120-150. In the preferred embodiment, the identified devices are those within wireless communication range of the WMI 100. For example, the WMI 100 can initiate a scan for nearby devices that are in a “discoverable” mode. In accordance with the Bluetooth protocol, wireless devices can be configured to be discoverable by other wireless devices. The WMI 100 can then identify nearby devices in the discoverable mode and determine their compatibilities. A device is compatible with the present invention if it supports the required specifications. If a device only supports some of the required specifications, it may still operate with the invention, but its capabilities may be limited accordingly. A list of devices identified by the WMI 100 is preferably provided to the user via the graphical display 102 as part of step 200. In one embodiment, only compatible devices are listed. In an alternative embodiment, incompatible devices are also listed and additional information is provided to enable the user to find corresponding firmware updates.

At this point, the user can choose to initialize one or more of the compatible devices in step 202. A user must initialize any device he or she desires to transfer content to or from. In the preferred embodiment, initialization occurs in accordance with “pairing” procedures specified by the Bluetooth protocol. Such procedures are well-documented in the prior art and can include various security measures that prevent unauthorized communications. An identified device is preferably paired or initialized with the WMI 100 upon a user selection, and a corresponding entry is added to database 110. This entry enables a user to bypass the initialization step during subsequent iterations of the workflow. In other words, each device only needs to be initialized once with a particular WMI.

FIG. 4A illustrates a sample device dataset 400 from database 110, wherein the dataset comprises a plurality of device entries. Dataset 400 includes fields for “Device ID” 402, “Device Name” 404, “Device Type” 406, and “Firmware Version” 408. The device ID 402 is preferably an alphanumeric identifier for each device that has been initialized by the WMI. The device ID 402 serves as a reference or key for other datasets in database 110. The device name 404 can be a default or a user-specified name for a device and is used to identify the device to the user via the graphical display 102. The device type 406 preferably defines the category of devices to which a specific device belongs. Categories are particularly useful when there are many devices available to the WMI 100, and the user can choose to organize the display of devices accordingly. Finally, the firmware version 408 identifies the particular firmware version that is installed on the device. The firmware version 408 enables the WMI to determine whether the device is compatible with the present invention.

Referring back to step 205 in FIG. 2, the WMI 100 queries the user via the graphical display 102 as to whether he or she would like to create a new profile or edit an existing profile. In the preferred embodiment, profiles comprise an identification of two or more devices, one or more content parameters, and one or more timing parameters. The identified devices are any for which the user desires to execute one or more data transfer or synchronization operations. The particular content that is to be transferred is specified via the content parameters. The constraints that trigger the transfer operation are specified via the timing parameters. Security parameters can also be specified to enable secure communications between devices.

If the user chooses to create a new profile, the WMI 100 queries the user to select two or more devices at step 210. Preferably, the WMI 100 will list each device that is available for selection. Again, it is noted that the WMI 100 could be one of the listed devices. Available devices can be sorted or arranged by device type as specified above or any other suitable characteristic. After the user has selected two or more devices, the WMI 100 will initialize a default profile for the selected devices at step 215. The default profile may be dependent upon the types of devices that are selected or a set of user preferences, or it may be completely bare of parameters.

If at step 205 the user chooses to edit an existing profile, the WMI 100 queries the user to select a particular profile from a list of saved profiles at step 220. The list of saved profiles can be sorted or arranged by the associated devices or any other suitable characteristic. In one embodiment, a user can select a particular device and access all profiles associated with that device. In an alternative embodiment, each profile is arranged according to its name. Profile information is preferably stored in database 110. Further information regarding the storage and maintenance of profile information is provided in more detail below.

Upon selecting an existing profile, the WMI 100 enables the user to add or remove devices from the profile at step 225. Adding and removing devices can be accomplished by utilizing ordinary graphical interface tools such as checkboxes, dropdown menus, radio buttons, etc.

For both new and existing profiles, the WMI 100 enables the user to edit one or more content parameters at step 230. As mentioned above, the content parameters specify the particular content that is to be transferred among the selected devices. Content parameters can range from being very simple to rather complex. For example, a user might only desire to transfer a few specific photos from digital camera 150 to wireless flash drive 140. This could be accomplished by viewing a list of photos presently stored on digital camera 150, selecting one or more of the photos, and designating a directory on the wireless flash drive 140 as the destination.

Alternatively, the user might want certain files stored on cell phone 130 to be synchronized with those stored on notebook computer 120. This could be accomplished by specifying a particular location of stored content on the cell phone 130, and specifying a similar location on the notebook computer 120. One or more rules can then be used to specify the type of synchronization that is to occur. For example, the user might desire that the specified locations on each device mirror each other. In such cases, when content is added to or removed from either location, the synchronization operation will take the appropriate measures (e.g., copy or delete files) at the other location. In an alternative form of synchronization, changes in content at a first location will be mirrored at a second location, but changes in content at the second location will not impact the content at the first location. There are many other rules and combinations of rules that may be specified to precisely meet the desires of the user. The examples provided herein are not meant to limit the scope of the invention. All rules can be selected and/or modified using well-known graphical interface techniques, e.g., drop-down menus, checkboxes, radio buttons, etc.

After the user edits the content parameters for a particular profile, he or she must edit the timing parameters in step 240. The timing parameters define the timing and frequency settings for the exchange of content. In the example above where the user only desires to transfer a few photos from the digital camera 150 to the wireless flash drive 140, he or she could specify a one-time transfer that is to occur automatically the next time the devices are within wireless communication range of each other. In the example where the user desires to synchronize the music files stored on cell phone 130 with those stored on notebook computer 120, he or she could specify that the synchronization operation is to occur once daily when the cell phone 130 is within wireless communication range of notebook computer 120. The user might also specify a particular time of day, a specific user input, or any other criteria that could trigger a transfer operation between two or more devices. For example, content can also be transferred between two devices in response to physically depressing an upload/transmit button located on a device. The wireless flash drive 140 preferably includes such a button.

The user might also specify one or more security parameters (not shown). Security parameters can be established so as to prevent unauthorized devices from accessing protected content. In one embodiment, security can simply be turned on or off, in which case a random key is automatically established for the two or more devices in the profile, and the content can only be exchanged between the devices when the appropriate key is supplied. Alternatively, more advanced security settings could be specified, such as a user-defined key or password, a certain type of encryption, etc.

To this point, profiles have been described as designating two or more distinct devices. However, a profile can also be established that designates a single device and one or more classes of devices. Example classes of devices include: all devices, business devices, entertainment devices, advertising devices, and information devices. Essentially, classes of devices enable a device to be “open” or “closed” to content from other unspecified devices. A device is “open” if it is configured to automatically transfer or receive content to or from devices in a certain class. A device is “closed” if it is configured to automatically prevent content transfer requests to or from devices in a certain class. For example, a user might select a music player device and an entertainment class of devices for a particular profile. The user can then specify via content parameters and timing parameters that the music player be open to automatically receive audio content from any device in the entertainment class. One could imagine the user walking into a retail music store, wherein devices of the entertainment class automatically push free audio content onto the music player. If the user wanted to be more specific, he or she could designate certain music genres of interest via the content parameters, and the music player would only accept music that satisfies the specified criteria. The same principles apply to enabling devices to receive documents from business devices, advertisements from advertising devices, informative tips, guides, or maps from information devices, or any content from any devices. Devices are preferably closed to all device classes by default and will only be able to transfer or receive content if specifically configured to do so. Naturally, a device class can be configured to encompass any set of devices according to any criteria, and the examples provided above are not intended to limit the scope of the invention.

Once all of the appropriate parameters have been established, the user can save the profile that he or she has been editing at step 250. This could be accomplished by selecting a “save” button and providing an alphanumeric identifier that distinguishes the profile from others. The profile would then be saved to database 110, preferably in the manner illustrated by FIG. 4B. FIG. 4B illustrates a sample profile dataset 420 from database 110, wherein the dataset comprises a plurality of profile entries. The profile dataset 420 comprises fields for “Profile Name” 422, “Dev. 1” 424, “Dev. 2” 426, “Operation” 428, “Rules” 430, and “Trigger” 432. The profile name 422 represents a default or a user-defined identifier for the profile. The numeric codes in Dev. 1 424 and Dev. 2 426 identify the particular devices from the device dataset 400 that are included in the profile. If a profile includes more than two devices, then there will be multiple entries in the table with the same profile name, wherein each additional entry defines a distinct transfer operation between two devices. The operation field 428 indicates the particular operation that is to be executed. For example, it preferably indicates whether the operation is a synchronization operation or a transfer operation, and it identifies the particular content that is to be synchronized or transferred. The rules field 430 stores the rules for the profile. For example, it may indicate that the first device is to mirror the second device, that both devices are to mirror each other, or it may describe any other rule or combination of rules that dictate the nature of the synchronization or transfer operation. Finally, the trigger field 432 specifies the triggering event for the associated operation. The operation could, for example, be configured to execute once daily whenever the two devices come within wireless communication range of each other, or the operation might only execute in response to a manual user input at one of the devices.

Referring back to step 260 in FIG. 2, each of the designated devices is configured in accordance with the parameters specified in the profile. The configuration instructions are preferably pushed to each of the devices immediately, but may be queued for a later time if one or more of the devices is not available. If the devices have not previously communicated with one another, it may be necessary to initialize or pair them with each other prior to executing a transfer operation. This process can be a manual transaction resulting from user input at the devices, or it may be automatically facilitated by the WMI 100.

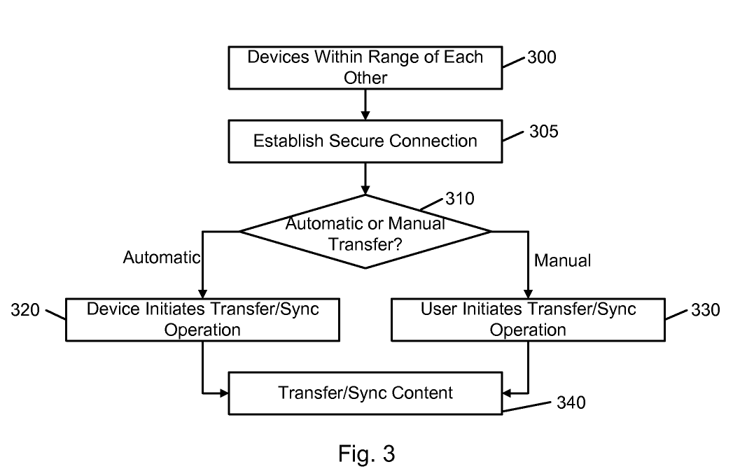

Once each of the devices specified in a profile have been properly configured, content can be transferred in accordance with the workflow illustrated in FIG. 3. At step 300, the devices must first be within wireless communication range of each other. For example, if digital camera 150 is configured to transfer photos to wireless flash drive 140, then digital camera 150 and the wireless flash drive 140 must be close enough in proximity such that each can communicate with the other. Both devices are preferably configured to automatically connect upon detecting the other device's presence. Once the devices have established a wireless connection at step 305, the designated content can be transferred automatically or manually in response to user input as illustrated at 310. If the devices are configured to transfer content automatically, the devices will initiate the corresponding transfer operation at step 320. Alternatively, if the devices are configured to transfer content manually, the devices will wait for a specific user input to trigger the corresponding transfer operation at step 330. In one embodiment, wireless flash drive 140 preferably includes several visual indicators such as LEDs. When the wireless flash drive 140 is within wireless communication range of a device with which it shares a profile, one of the visual indicators is illuminated to alert the user that a transfer or synchronization operation is permissible. The user can then depress a button on the body of the wireless flash drive 140 to initiate the corresponding operation.

Finally, at step 340, the devices will transfer the content as specified in the corresponding profile. Once the transfer is complete, one or more of the devices may emit a tone, flash a light, or indicate via some other means that the transfer was either successful or unsuccessful. In the wireless flash drive 140 example presented immediately above, a second visual indicator is preferably illuminated to indicate the successful completion of a synchronization operation. If the operation fails, a third visual indicator might illuminate to alert the user that a problem was encountered.

The inventors envision that the present invention will enable a user to establish a personal wireless ecosystem, wherein each of the wireless devices in the ecosystem can be configured to synchronize content with other devices in the ecosystem as well as non-specific devices outside the ecosystem. Such an ecosystem will effectively reduce, if not eliminate, the limitations that presently prevent users from easily transferring content between wireless devices. Furthermore, it will generally provide a significant improvement for data redundancy and content sharing across a wide variety of wireless devices that previously could not communicate with each other.

The foregoing merely illustrates the principles of the invention. It will thus be appreciated that those skilled in the art will be able to devise various arrangements which, although not explicitly described or shown herein, embody the principles of the invention and are thus within its spirit and scope. These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts is intended to be required unless specifically indicated; and
i) the term “plurality of” an element includes two or more of the claimed element, and does not imply any particular range of number of elements; that is, a plurality of elements can be as few as two elements, and can include an immeasurable number of elements.

We claim:

1. A method comprising:
displaying a plurality of device representations;
providing a graphical interface to facilitate user selections;
receiving a selection of a first device;
receiving a selection of a second device;
receiving a selection of one or more content parameters;
receiving a selection of one or more timing parameters; and
configuring the first device to wirelessly transfer content to the second device based on the content parameters and the timing parameters.

2. The method of claim 1, including receiving a selection of one or more synchronization rules.

3. The method of claim 1, including receiving a selection of one or more security parameters.

4. The method of claim 1, wherein the first device is configured to transfer the content to the second device automatically when the first device is within wireless communication range of the second device.

5. The method of claim 1, wherein the first device is configured to transfer the content to the second device in response to a user input at one of:
the first device, and
the second device.

6. The method of claim 1, wherein
the plurality of device representations are displayed at a third device, and
the graphical interface is provided by the third device.

7. The method of claim 6, wherein the one or more content parameters and the one or more timing parameters are stored in a database that is accessible to the third device.

8. The method of claim 1, wherein the first device and the second device communicate wirelessly via one of:
Bluetooth,
WiFi,
radio frequency, and
infrared.

9. The method of claim 1, wherein the first device is one of:
a wireless headset, and
a wireless flash drive.

10. The method of claim 9, wherein the second device is one of:
a wireless headset, and
a wireless flash drive.

11. A method comprising:
displaying a plurality of device representations;
providing a graphical interface to facilitate user selections;
receiving a selection of a first device;
receiving a selection of a device class;
receiving a selection of one or more content parameters;
receiving a selection of one or more timing parameters; and
configuring the first device to wirelessly receive content from an unspecified second device belonging to the device class based on the content parameters and the timing parameters.

12. The method of claim 11, wherein the first device is configured to automatically receive content from the unspecified second device when the first device is within wireless communication range of the unspecified second device.

13. The method of claim 11, wherein the first device is configured to automatically receive content from the unspecified second device upon receiving a user input at the first device.

14. The method of claim 11, wherein the device class is one of:
a business class,
an entertainment class,
an advertising class,
an information class, and
all devices.

15. A system comprising:
a display configured to display a plurality of device representations;
a graphical interface configured to facilitate user selections of each of the following:
a first device,
a second device,
one or more content parameters, and
one or more timing parameters; and
a management device configured to instruct the first device to wirelessly transfer content to the second device based on the content parameters and the timing parameters.

16. The system of claim 15, wherein the management device is one of:
the first device, and
the second device.

17. The system of claim 15, wherein the display and the graphical interface are provided by the management device.

18. The system of claim 17, wherein the management device is configured to instruct the first device to automatically transfer the content to the second device when the first device is within wireless communication range of the second device.

19. The system of claim 17, wherein the management device is configured to instruct the first device to transfer the content to the second device upon receiving a user input at one of:
the first device, and
the second device.

20. A computer readable medium including computer-executable instructions that are configured to cause a computer to:
display a plurality of device representations;
provide a graphical interface to facilitate user selections;
receive a selection of a first device;
receive a selection of a second device;
receive a selection of one or more content parameters;
receive a selection of one or more timing parameters; and
configure the first device to wirelessly transfer content to the second device based on the content parameters and the timing parameters.

21. The computer readable medium of claim 20, wherein the computer executable instructions are configured to cause the computer to:
instruct the first device to automatically transfer the content to the second device when the first device is within wireless communication range of the second device.

22. The computer readable medium of claim 20, wherein the computer executable instructions are configured to cause the computer to:
instruct the first device to transfer the content to the second device upon receiving a user input at one of:
the first device, and
the second device.
